(19) United States
(12) Patent Application Publication
(10) Pub. No.: US 2012/0011984 A1
(43) Pub. Date: Jan. 19, 2012

(54) INTERCHANGEABLE STRING INSTRUMENT

(76) Inventor: Rafael Atijas, Montevideo (UY)

(21) Appl. No.: 13/181,735

(22) Filed: Jul. 13, 2011

Related U.S. Application Data
(60) Provisional application No. 61/364,299, filed on Jul. 14, 2010.

(51) Int. Cl. G10D 3/00

(52) U.S. Cl. 84/293

(57) ABSTRACT

A stringed instrument such as an acoustic guitar in which the proximal end of the body of the stringed instrument and the distal end of the neck are configured so that the body and neck are completely interchangeable with other pre-manufactured bodies and necks is described. In one preferred embodiment, the configuration at the proximal end of the body includes a recess which is configured to receive different types of necks whose distal end is in turn configured to fit into the recess. In one embodiment, the necks differ in length as well as in the length of scales on the necks. Also included are kits as well as assemblies of the various components used to construct a stringed instrument according to the different embodiments of the invention. The easy interchangeability of the various types of necks and bodies due to the simplistic design of the instrument combined with limiting the instrument in certain preferred embodiments to three strings offers maximal flexibility to serve the functional and esthetic needs of an intended user. Examples include the need of a child who can start off with a shorter neck and then later exchange the shorter neck of the instrument for a longer neck as the child grows. Other examples include the substitution of a certain shaped body for a differently shaped body.

### CROSS-REFERENCE TO RELATED APPLICATION

This application claims the benefit and priority of U.S. Provisional Patent Application No. 61/364,299, filed Jul. 14, 2010, which is incorporated herein by reference.

### STATEMENT REGARDING SPONSORED RESEARCH OR DEVELOPMENT

This invention was made in part with government support from Uruguay's ANII (Agencia Nacional de Investigación e Innovación), Proyecto ANII N° PE_ACM_{—}2010_{—}2163.

### FIELD OF THE INVENTION

This invention relates to stringed instruments, and more particularly, to guitars.

### BACKGROUND OF THE INVENTION

There are numerous types of stringed instruments such as guitars and banjos which are known in the art. Conventional guitars comprise a body and neck with strings stretched and tensioned between the distal end of the neck and a bridge mounted on the body. The neck is typically integral with the body of the guitar. However, various modifications have been made to guitars over the years often for ease of production and repair so that the neck is detachable from the body. Many of the patents disclosing detachable necks focus upon the type of detachment mechanism used. For example, U.S. Pat. No. 5,353,672 discloses a guitar having a releasable latch mechanism comprising a neck plate fixed to the underside of the neck and a spring biased latch on the body and engageable with the neck. U.S. Pat. No. 7,375,267 discloses a detachable neck where the detachment mechanism includes a lever actuating clamp providing a clamping force substantially parallel with the longitudinal axis of the neck and body and the tensioned strings so that when reassembled the guitar strings regain their prior pre-assembled state of tune. Each of these patents focuses solely on making the existing neck and body detachable and do not disclose interchangeability of different types of guitar bodies with different type of guitar necks.

U.S. Pat. No. 3,657,462 discloses a guitar having a detachable neck and body where a U-shaped groove of the neck is adapted to receive a tongue in the body of the guitar. The patent contemplates a variety of different detachable bodies which could be connected to the same neck using the attachment mechanism of the invention. However, the invention is limited to solid body electrical guitars and does not disclose the interchangeability of different types of necks. U.S. Pat. No. 5,949,005 discloses an assembly which provides users a way to modify any existing guitar to become collapsible for compact storage and is limited to modifying existing guitars. U.S. Pat. No. 6,046,392 discloses an interchangeable soundboard and an interchangeable neck. However, the bridge is included on the neck so that the stringed part of the instrument remains in one piece, and the design of the guitar is such that the neck must be placed well into the body of the guitar. In total, none of the aforementioned patents discloses a stringed instrument in which both the neck and body are easily interchangeable so as to adapt to the functional and esthetic needs of a user as will be described of the present invention.

### SUMMARY OF THE INVENTION

The present invention is directed to a stringed instrument in which the proximal end of the body of the guitar and distal end of the neck of the instrument are configured so that the body and neck are completely interchangeable with other pre-manufactured bodies and necks of the instrument. In one embodiment, the configuration at the proximal end of the body includes a recess which can receive different necks, and the distal end of said necks are configured to fit into the recess of the bodies. The proximal end of the neck is secured to the recess with an attachment apparatus such as screws and an associated washer. In one preferred embodiment, the pre-manufactured necks differ in length as well as in scale length. In another preferred embodiment, the pre-manufactured bodies differ in size. In a particularly preferred embodiment, the stringed instrument is a three string instrument which offers easier use of the instrument. In yet another preferred embodiment, the instrument is an acoustic guitar.

In a separate aspect, the invention includes an assembly of different instrument bodies and different necks, each neck and body which is easily interchanged with each other so as to construct a desired stringed instrument. In one embodiment, the stringed instrument assembly comprises bodies having different shapes and necks having different lengths. The different size neck is particularly desirable from the standpoint of a child who can start off with a shorter length neck and then simply exchange the shorter neck with a longer neck using the same body. In this manner, the instrument can grow with the child. The assembly is also advantageous from an esthetic viewpoint of a user who wants, for example, to exchange one shaped body with a different shaped body included in the stringed instrument assembly.

In yet another aspect, the invention includes kits containing unassembled components which can be easily assembled to construct a stringed instrument according to the various embodiments of the present invention.

### BRIEF DESCRIPTION OF THE DRAWINGS

FIG. 1 is a front perspective view of a stringed instrument according to one preferred embodiment.

FIG. 2 is an exploded front perspective view of the body according to one preferred embodiment. Also shown is attachment of the bridge onto the body.

FIG. 3 is an exploded front perspective view of the body according to one preferred embodiment of the invention. Also shown is attachment of the tailpiece onto the body.

FIG. 4 is a front perspective view of the assembled body according to one embodiment of the invention.

FIG. 5 is a perspective view of the body from the top according to one embodiment of the invention.

FIG. 6 is an exploded perspective view of the neck according to one embodiment of the invention.

FIG. 7 is a perspective view of the assembled neck according to one embodiment of the invention.

FIG. 8 is a front plan view illustrating the length of the neck according to one embodiment of the invention.

FIG. 9 is a front plan view illustrating an alternate length of the neck according to a separate embodiment of the invention.

FIG. 10 is an exploded front perspective view of an unassembled neck and body according to one embodiment of the invention.

FIG. 11 is a front perspective view of an assembled neck and body according to one embodiment of the invention.

FIG. 12 is an exploded perspective rear view of an unassembled neck and body according to one embodiment of the invention.

FIG. 13 is a front perspective view of the stringed instrument showing a triangular shaped body according to one embodiment of the invention.

FIG. 14 is a front perspective view of the stringed instrument showing an irregular shaped body according to one embodiment of the invention.

FIG. 15 is a front perspective view of the stringed instrument showing a rectangular shaped body according to one embodiment of the invention.

### DETAILED DESCRIPTION OF THE INVENTION

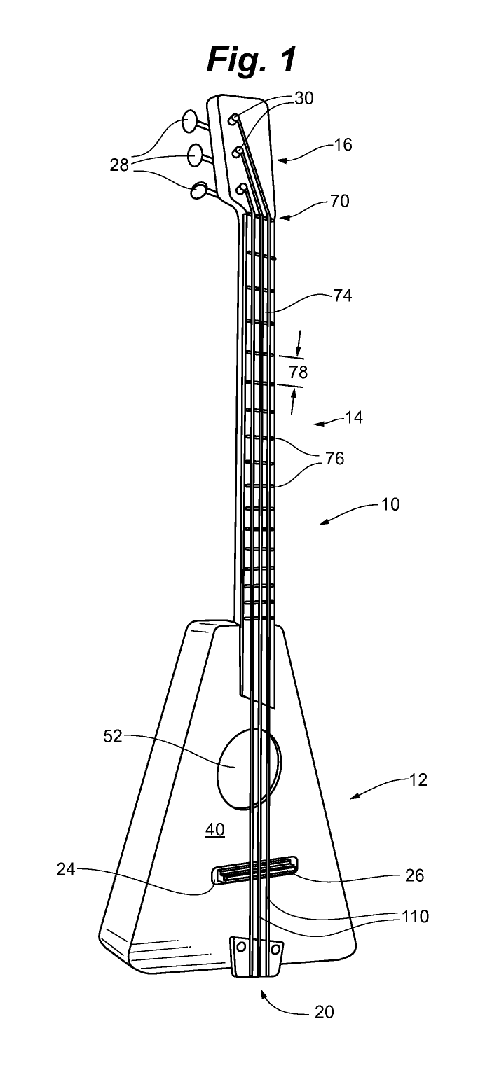

Referring to FIG. 1, the structure of a preferred embodiment of the present invention is illustrated. The stringed instrument 10 includes a body 12 and a neck 14 extending from body 12. Neck 14 is connected to headstock 16. Associated components which are included on body 12 are tailpiece 20, a bridge 24 and saddle 26. Associated parts which are included on headstock 16 are tuning keys 28 and connectors 30.

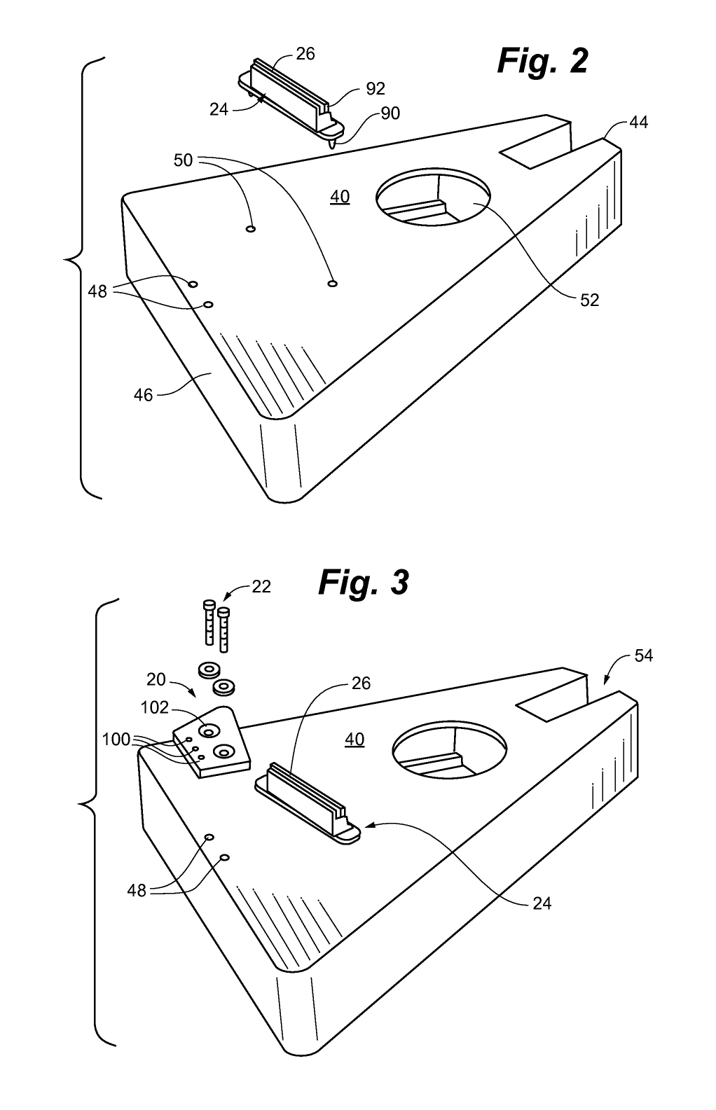

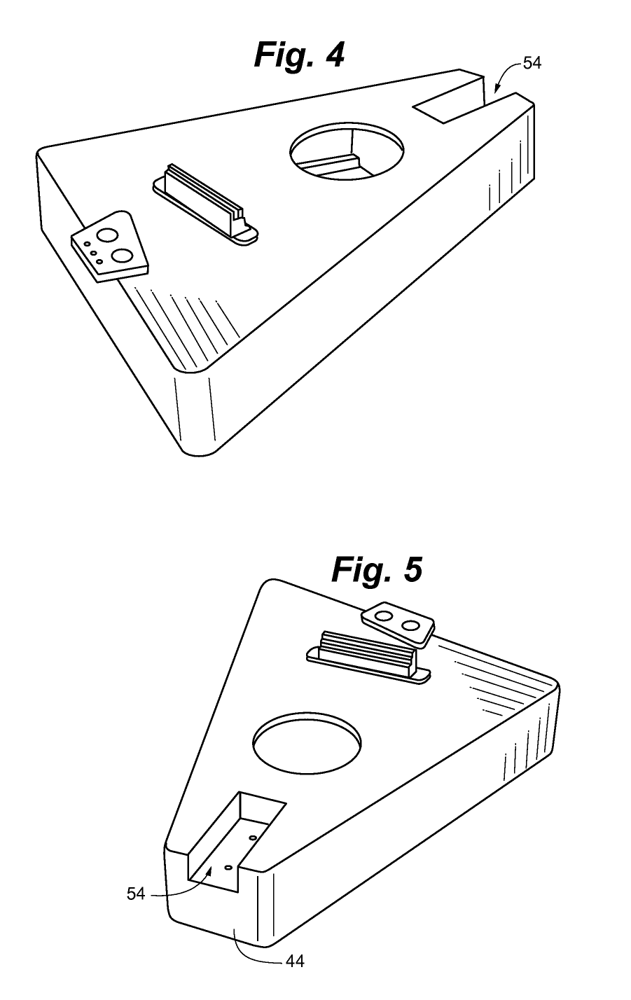

As shown in FIGS. 2-3 body 12 includes a front surface 40, a rear surface 42 (shown in FIG. 12), a proximal end 44, and a distal end 46. Included in the front surface 40 at the distal end 46 of body 12 are one or more components for attaching strings 110 (shown in FIG. 1) to the distal end 46 of body 12 such as a bridge 24, its associated saddle 26, and tailpiece 20. Preformed holes 48 are used to receive an attaching mechanism such as screws and their associated washers 22 in order to secure tailpiece 20 onto the front surface 40 at the distal end 46 of body 12. Parallel to holes 48 are preformed holes 50 used to receive pegs 90 on bridge 24. The bridge 24 contains a cavity 92 in which saddle 26 is firmly held. Moving towards the proximal end 44, body 12 also includes a sound hole 52. The proximal end 44 of body 12 is configured to receive the distal end of different type necks for the stringed instrument. In the embodiment shown in FIGS. 2-5, the proximal end 44 of body 12 includes a recess 54 which is configured to receive the distal end 72 of neck 14. The configuration of recess 54 is such that it receives distal end 72 of different type necks. In a preferred embodiment, the necks are different in their lengths. In one preferred embodiment which is shown in FIGS. 2-5, recess 54 is rectangular in shape. In a preferred embodiment, the rear surface 42 of body 12 further includes one or more holes 56 at the proximal end 44 which are used to receive an attachment apparatus such as screws and an associated washer 18 (shown in FIG. 12).

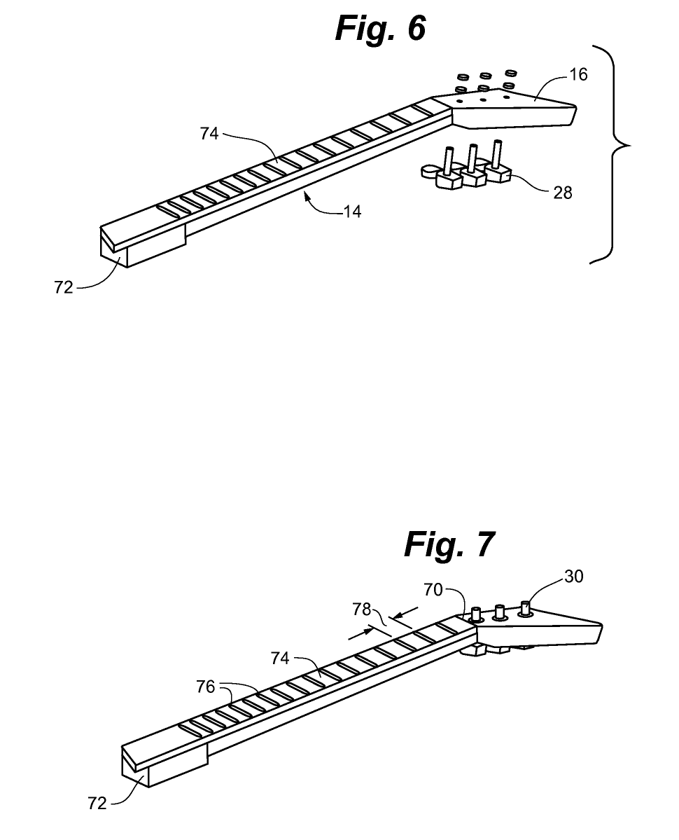

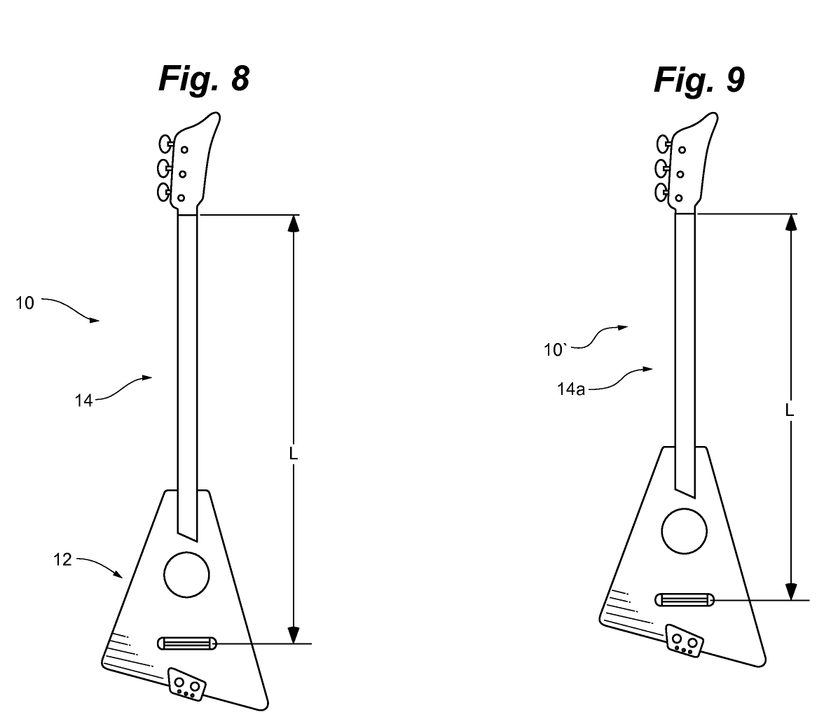

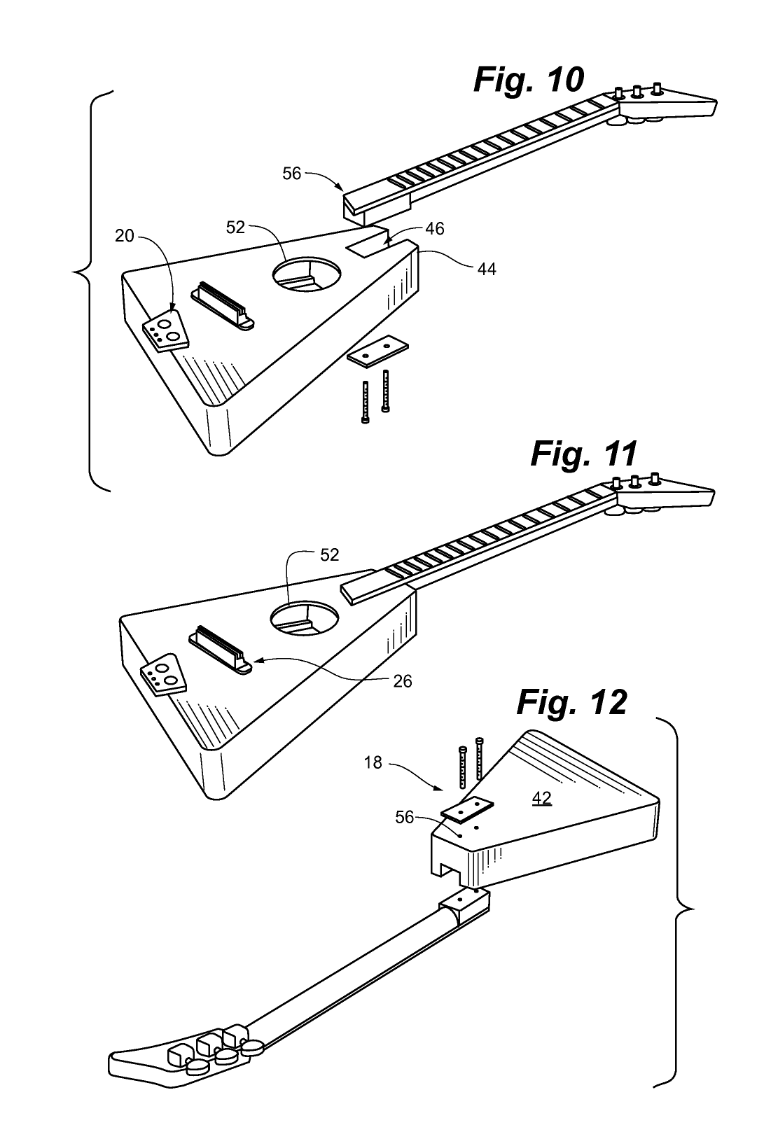

As is shown in FIGS. 6-7, neck 14 includes a proximal 70 and distal 72 end. Covering the front surface (not shown) of neck 14 is a fretboard 74 which includes frets 76. The distance between each fret is known as a scale length and is marked as 78. The distal end 72 of neck 14 is conformed to fit into recess 54 at the proximal end 44 of body 12. As is most clearly shown in FIG. 12, an attaching apparatus is used to securely attach the distal end 72 of neck 14 to the recess 54 of body 12 such as screws and its associated washer 18. In this preferred embodiment, the screws are screwed into holes 56 on the rear surface 42 of body 12 and into pre-formed holes included on the rear surface of neck 14 so as to firmly attach the distal end 72 of neck 14 to the proximal end 44 of body 10. Different types of necks can easily be substituted for neck 14 according to the various embodiments of the invention so long as the distal end of each neck is conformed to fit into recess 54 at the proximal end 44 of the body 12 and vice versa. One preferred embodiment includes necks which differ in their length. As is most clearly illustrated in FIGS. 8-9, such lengths are customarily measured from the proximal end of the neck to the bridge. Importantly, the different length necks 14 and 14a also differ in the scale length 78 in the proper proportions and lengths, as known to one skilled in the art, in order for the instrument to still tune correctly without the need to modify the location where bridge 24 sits on body 12.

As shown in FIG. 1, stringed instrument 10 also includes a plurality of strings 110. In the preferred embodiment shown in FIG. 1, the plurality of strings consists of three strings. As opposed to the standard number of strings in guitars which is six, limiting the instrument to three strings is particularly advantageous from the aspect of a child user because it makes the stringed instrument much easier to play. In addition, limiting the guitar to three strings also allows for a much narrower neck than a traditional guitar which is particularly advantageous from the aspect of usability and comfort for a child. A three string as opposed to the conventional six string instrument also makes the instrument faster to tune. As is shown in the embodiment of FIG. 1, strings 110 are secured to stringed instrument 10 by attaching one end to one of the connectors 30 on headstock 16 and the opposing end through one of the holes 100 (shown in FIG. 3 and fflg.) in tailpiece 20 such that the lower portion of strings 110 rests securely on saddle 26.

Although no precise order of assembly is required, one example of assembly according to one embodiment is the following: First, the neck 14 is connected to the proximal end 44 of body 12 using an attaching apparatus such as screws and an associated washer 18 (shown in FIG. 12). Next, the tailpiece 20 is connected to body 12 using an attachment apparatus such as screws and associated washer 22 (shown in FIG. 3). These screws are then screwed into preformed holes 102 in tailpiece 20 and secured to body 12 through preformed holes 48 in body 12. Next, tuning keys 28 and connectors 30 are attached to the headstock 16 of neck 14 (shown in FIGS. 6-7). Bridge 24 is then snapped into holes 50 and saddle 26 is fitted into the cavity 92 in the bridge 24 (shown in FIG. 2). Next, strings 110 are attached to instrument 10 by inserting each end of strings 110 through one of holes 100 in tailpiece 20 and making a knot. The opposite end of each one of strings 110 is then tied to its parallel connector of tuning connectors 30. Finally, each of tuning keys 28 are rotated until a desired tension of strings 110 is achieved thereby tuning the stringed instrument 10. Disassembly of stringed instrument 10 is simply the reverse of assembly starting with the last step.

Although there are many orders of assembling the various unassembled components of the stringed instrument, both assembly and disassembly is easily accomplished due to the simple design of the stringed instrument. This is an important feature because the instrument is intended for users such as children who will want to exchange one body of the instrument for another or one neck of the instrument for another. Easy assembly and disassembly is also advantageous from the perspective of a user like a child because it enables the child who is unfamiliar with the various parts of the stringed instrument to become more familiar with the various parts and thus serves as an educational experience for that user.

Although various types of stringed instruments are contemplated, one particularly preferred and another novel embodiment of the invention is to limit the stringed instrument to a three-stringed acoustic guitar. As stated, limiting the instrument to three strings makes the instrument easier to play for an intended user such as a child. Acoustic guitars use air, vibrating strings, and a body shape to produce sound as opposed to electric guitars which produce sound by amplifying the vibrating strings using electronics.

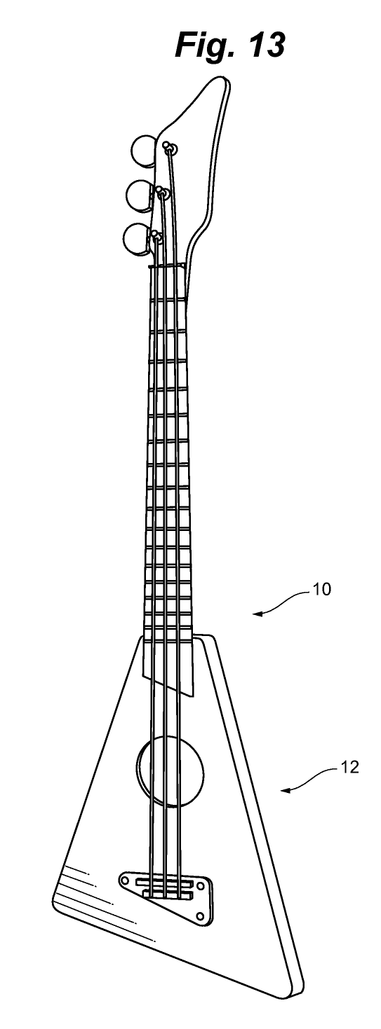

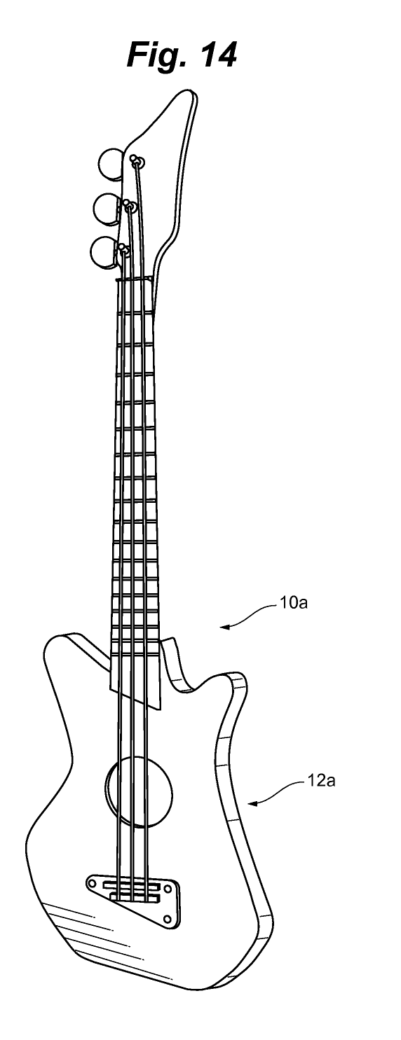

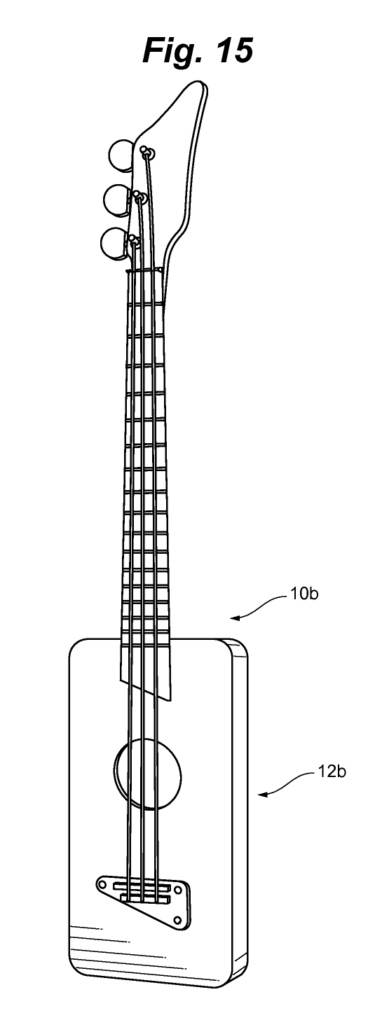

As stated, another novel and important feature of the stringed instrument is that body and neck of the instrument are completely interchangeable with other pre-manufactured bodies and necks. This feature of the invention is advantageous because the stringed instrument will serve both functional and esthetic needs of its user. As a functional needs example, an intended user such as a child can start off with a stringed instrument which has a shorter neck. After the child has grown, the shorter neck can thereafter be disassembled from the body and exchanged for a longer neck which can then be easily secured to the body of the guitar. In this manner, the instrument can grow with the child. As for an esthetic example (shown in FIGS. 13-15), the intended user might start off with a stringed instrument having a triangle shaped body 12 along with neck 14 as was previously described according to one preferred embodiment of the invention and latter exchange the triangle shaped body 12 for an irregular shaped body 12(a) or for a rectangular shaped body 12(b) using the same sized neck 14. In this manner, the invention allows the user to easily exchange components of the current invention without the need for either purchasing an entire new stringed instrument or modifying the existing instrument so that the body and the neck can be interchanged.

The invention also covers an assembly of various interchangeable necks and bodies, each of which is interchangeable. In one embodiment, the stringed instrument assembly includes several differently shaped bodies (12, 12(a), 12(b)) and several different length necks (14, 14(a)). Any one of the different length necks (e.g., 14 and 14(a)) is configured so as to fit into any one of the different shaped bodies (e.g., 12, 12(a), 12(b)) of the assembly and vice versa. In this way, an intended user can simply go to a website depicting all of the various interchangeable necks and bodies and conveniently choose a desired body or neck without the need for purchasing an entirely new instrument. For example, an intended user such as a child would want to start out with a short neck and then as the child grows substitute that shorter neck for a longer neck in the assembly. Similarly, an intended user who wants esthetic variety may start out by purchasing the stringed instrument with one body shape and then later choose a different type shape without the need to purchase an entirely new guitar Importantly, the different pre-manufactured necks in the assembly are not only different in lengths but also different in scale length which is typically measured as the distance between the frets. This is important because it allows different length necks to be exchanged and the instrument to still tune correctly without the need to modify the location where the bridge sits on the body of the instrument.

Also covered by the present invention are kits (not shown) of the present invention. Such kits include a package (not shown) containing all of the necessary components to easily assemble stringed instruments according to the various embodiments of the present invention. In a preferred embodiment the unassembled components of stringed instrument 10 includes a body 12, the neck 14 with attached headstock 16, attaching apparatus such as screws and associated washer 18 used to attach body 12 to neck 14, a tailpiece 20, attaching components such as screws 22 to attach tailpiece 20 to body 12, a bridge 24 and saddle 26, strings 110, and tuning keys 28. Included with kits of the current invention are instructions (not shown) for assembly. Also included in such kits are optional accessories such as pickguards (not shown). Pickguards protect the body finish from damage caused by a pick or fingernail and typically are made of plastic.

The principles, preferred embodiments and modes of operation of the present invention have been made apparent in the foregoing description. The invention should not be construed as limited to the described embodiments. Instead, the embodiments described herein should be regarded as illustrative and not restrictive in any way. Variations and changes may be made by others without departing from the intent of the present invention as defined by the following claims.

What is claimed is:

1. A stringed instrument comprising:
a body having a front surface, a rear surface, a proximal end, a distal end and a recess at said proximal end of said body;
a neck having a proximal end and a distal end;
said recess of said body being configured to receive said proximal end of said neck as well as proximal ends of different type necks which can be substituted for said neck;
said distal end of said neck being configured to fit into said recess of said body and further configured to fit into a recess included on different types of bodies which can be substituted for said body of said stringed instrument;
a headstock which is attached to said proximal end of said neck, said headstock including a plurality of tuning keys and tuning connectors;
an apparatus used to secure said proximal end of said neck to said recess of said body;
and a plurality of strings supported by and between said connectors on said headstock and one or more apparatuses on said body of said instrument.

2. The stringed instrument of claim 1, wherein said stringed instrument is an acoustic guitar and said plurality of strings consists of three strings.

3. The stringed instrument of claim 1, wherein said different types of bodies are different in shape.

4. The stringed instrument of claim 2, wherein said different types of bodies are different in shape.

5. The stringed instrument of claim 1, wherein said different types of necks differ in neck length and scale length.

6. The stringed instrument of claim 2, wherein said different types of necks differ in neck length and scale length.

7. The stringed instrument of claim 1, wherein said apparatus used to attach said proximal end of said neck to said recess of said body is a set of screws and an associated washer.

8. The acoustic guitar of claim 2, wherein said apparatus used to attach said proximal end of said neck to said recess of said body is a set of screws and an associated washer.

9. A stringed instrument assembly comprising:
at least one body, said body having a front surface, a rear surface, a proximal end, a distal end and a recess at said proximal end, wherein said recess is configured so as to accept a plurality of different type necks, each of said plurality of different type necks having a proximal end and a distal end, wherein said distal end is configured to fit into said recess of each of said different type bodies, each of said different type necks further including a headstock attached to said proximal end, said headstock including a plurality of tuning keys and tuning connectors, and one or more apparatuses on said body, said one or more apparatuses used to connect a plurality of strings to said connectors on said headstock of each of said different types necks in order to construct a stringed instrument.

10. The stringed instrument assembly of claim 9, wherein said stringed instrument is an acoustic guitar and said plurality of strings consists of three strings.

11. The stringed instrument assembly of claim 9 having a plurality of different type bodies, wherein each of said different type bodies are different in shape.

12. The stringed instrument assembly of claim 10 having a plurality of different type bodies, wherein each of said different types bodies are different in shape.

13. The stringed instrument assembly of claim 9, wherein at least one of said different type necks differs in neck length and scale length from at least one other of said different type necks.

14. The stringed instrument assembly of claim 13 further comprising at least one bridge on said body, wherein when at least one of said different type necks differs in neck length and scale length from at least one other of said different type necks, said neck lengths and scale lengths are proportioned so that said stringed instrument assembly will tune correctly without modifying where the bridge sits on said body.

15. The stringed instrument assembly of claim 9, further including an apparatus used to securely attach said distal end of said neck to said proximal end of said body.

16. The stringed instrument assembly of claim 15, wherein said apparatus is one or more screws and an associated washer.

17. The stringed instrument of claim 1, wherein said one or more apparatuses on said body comprises and bridge, a saddle and a tailpiece.

18. A kit used to construct a stringed instrument comprising:
a body having a front surface, a rear surface, a proximal end, a distal end and a recess at said proximal end of said body;
a neck having a proximal end and a distal end;
said recess at said proximal end of said body being configured so as to accept said proximal end of said neck of said stringed instrument as well as configured to receive the proximal end of different type necks which can be substituted for said neck of said stringed
said distal end of said neck being configured to fit into said recess of said body of said stringed instrument as well as configured to fit into a recess on different types of bodies which can be substituted for said body of said stringed instrument;
a headstock which is attached to said proximal end of said neck, said headstock including a plurality of tuning keys and tuning connectors;
an apparatus used to attach said proximal end of said neck to said recess of said body;
a plurality of strings supported by and between said connectors on said headstock and one or more apparatuses on said body of said instrument;
and instructions for use of said kit used to construct a stringed instrument.

19. The kit of claim 18, wherein said stringed instrument is an acoustic guitar and said plurality of strings consists of three strings.

20. The acoustic guitar of claim 18, wherein said different types of necks differ in neck length and scale length.
